(19) United States
(12) Patent Application Publication
(10) Pub. No.: US 2010/0027392 A1
(43) Pub. Date: Feb. 4, 2010

(54) APPARATUS AND METHOD FOR CALIBRATING OPTICAL STORAGE DEVICE

(76) Inventors: Gwo-Huei Wu, Taipei Hsien (TW); Yi-Chen Tseng, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/185,137

(22) Filed: Aug. 4, 2008

(51) Int. Cl. G11B 7/00

(52) U.S. Cl. 369/47.53; G9B/7

(57) ABSTRACT

An apparatus for calibrating an optical storage device includes a clock generator, a jitter meter, and a calculation unit. The clock generator is utilized for providing a clock signal; the jitter meter is utilized for obtaining a plurality of data-to-data jitter values of a plurality of radio frequency (RF) signals according to the clock signal; and the calculation unit is utilized for determining a minimum jitter value among the plurality of data-to-data jitter values.

### BACKGROUND

The present invention relates to apparatuses and methods for calibrating an optical storage device, and more particularly, to apparatuses and methods for calibrating the optical storage device by utilizing a data-to-data jitter meter.

In high-density optical storage devices such as DVD, Blu-ray or HD-DVD, jitter plays an important role in evaluating and determining data quality (i.e., quality of radio frequency (RF) signals). However, in the optimal power calibration (OPC) area or any power calibration area (PCA) on an optical disc, because pits on the OPC area are formed by driving a laser diode with different recording powers, the quality of the RF signal from the OPC area is unstable. Therefore, when calibrating the recording power in the OPC area, an unstable jitter measuring result may occur due to the poor quality of the RF signal.

### SUMMARY

It is therefore an objective of the claimed invention to provide an apparatus comprising a wobble PLL and a data-to-data jitter meter, and related methods to solve the above-mentioned problem.

According to one embodiment of the present invention, a method for calibrating an optical storage device comprises: providing a clock signal; obtaining a plurality of data-to-data jitter values of a plurality of radio frequency (RF) signals according to the clock signal; and determining a minimum jitter value among the plurality of data-to-data jitter values

According to another embodiment of the present invention, an apparatus for calibrating an optical storage device comprises a clock generator, a jitter meter, and a first calculation unit. The clock generator is utilized for providing a clock signal; the jitter meter is utilized for obtaining a plurality of data-to-data jitter values of a plurality of radio frequency (RF) signals according to the clock signal; and the first calculation unit is utilized for determining a minimum jitter value among the plurality of data-to-data jitter values.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus for calibrating an optical storage device according to a first embodiment of the present invention.

FIG. 2 is a diagram illustrating a calculation of the data-to-data jitter value.

FIG. 3 is a diagram illustrating the fitting-curve of the data-to-data jitter values.

FIG. 4 is a diagram illustrating an apparatus for calibrating an optical storage device according to a second embodiment of the present invention.

FIG. 5 is a diagram illustrating determination of the beta target and the beta slope.

FIG. 6 is a diagram illustrating an apparatus 600 for calibrating an optical storage device according to a third embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

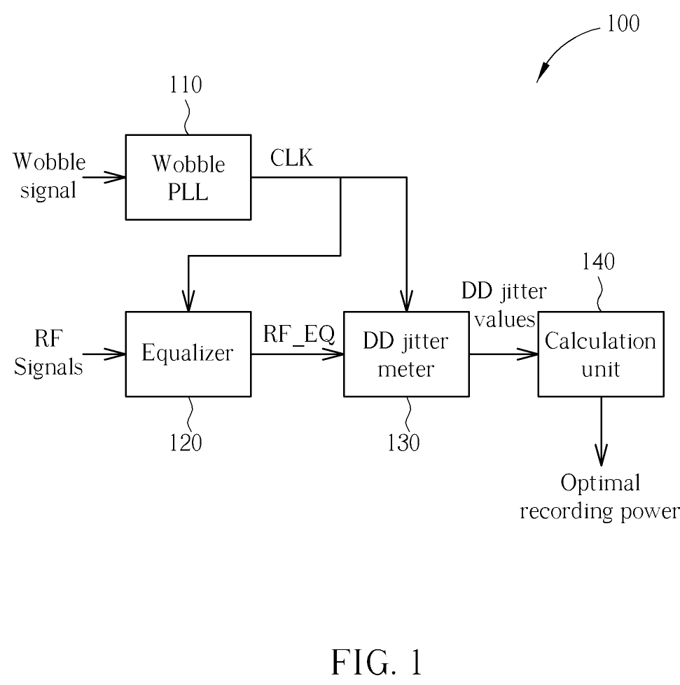

Please refer to FIG. 1. FIG. 1 is a diagram illustrating an apparatus 100 for calibrating an optical storage device according to a first embodiment of the present invention. As shown in FIG. 1, the apparatus 100 comprises a wobble phase-locked loop (PLL) 110, an equalizer 120, a data-to-data (DD) jitter meter 130, and a calculation unit 140. The operations of the apparatus 100 are described as follows.

In an optimal power calibration (OPC) area on the optical disc, pits on each sector (or each circle) are typically formed by different recording powers, and an optical pick-up head receives the information from the OPC area to generate a plurality of radio frequency (RF) signals and a wobble signal, wherein the RF signals and the wobble signal is respectively derived corresponding to stored data and the structure of the disc. It is noted that quality of the RF signals is related to recording power.

The wobble signal is inputted into the wobble PLL 110 to generate a clock signal CLK, where a period of the clock signal CLK is 1T. The period “T” is defined in specifications of optical storage devices, and pit lengths are represented by this symbol (such as 2T-9T). The equalizer 120 receives the RF signals and generates an equalized RF signal RF_EQ. Then, the DD jitter meter 130 obtains a plurality of DD jitter values of the RF signals according to the equalized RF signal RF_EQ and the clock signal CLK. Finally, the calculation unit 140 determines a minimum jitter value among the DD jitter values, and thus an optimal recording power is determining according to the minimum jitter value.

In this embodiment, the clock signal CLK is generated according to the wobble signal. In addition, taking 1T as the period of the clock signal CLK is a preferred example, the period of the clock signal CLK can also be less than 1T, for example 1T divided by a positive integer.

Compared with the conventional data-to-clock jitter meter, the DD jitter meter 130 in the apparatus 100 can determine the jitter value without locking the phases between the RF signal and the clock signal CLK. It is noted that the quality of the RF signal is affected by recording power easily, and thereby the data PLL derived from the RF signals loses lock probably. In contrast, the effective wobble signal (disc structure determined) is far less in frequency comparing to RF signal, and such that after some signal processing (for example, band-pass filter), the quality of generated wobble signal in general is not affected by recording power easily. Thus, the wobble PLL 100 has wider stable region in recording power comparing to data PLL. And then DD jitter meter 130 can generate more valid jitter values with using wobble PLL than data PLL (since jitter is related to PLL stability). Accordingly, using wobble PLL 100 in the curve fitting to find the minimum jitter value will generate more stable results than using data PLL does.

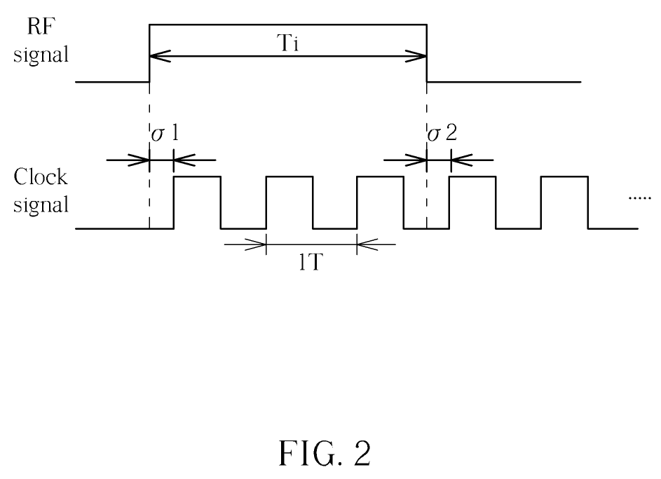

FIG. 2 is a diagram illustrating a calculation of the DD jitter value. In FIG. 2, a clock signal with a period 1T is utilized to measure a pulse width Ti of the RF signal. As shown in FIG. 2, three pulses of the clock signal correspond to the pulse width of the RF signal, σ1 represents a phase error between a rising edge of the pulse of the RF signal and the clock signal, and σ2 represents a phase error between a falling edge of the pulse of the RF signal and the clock signal. The pulse width Ti is calculated by the following formula:

Ti=3T+σ1−σ2;

The above-mentioned steps are repeated to calculate a plurality of pulse widths Ti, and an average pulse width Ta is determined according to these pulse widths Ti. Then, DD jitter values are calculated according to width errors between each pulse width Ti and the average pulse width Ta, i.e. (Ti-Ta). It is noted that the above steps for calculating the DD jitter value are for illustrative purposes only. The DD jitter value can also be determined according to other methods, such as the pulse width standard deviation. As long as the pulse widths Ti are generated from the above formula, these alternative representations of jitter value are all within the scope of the present invention.

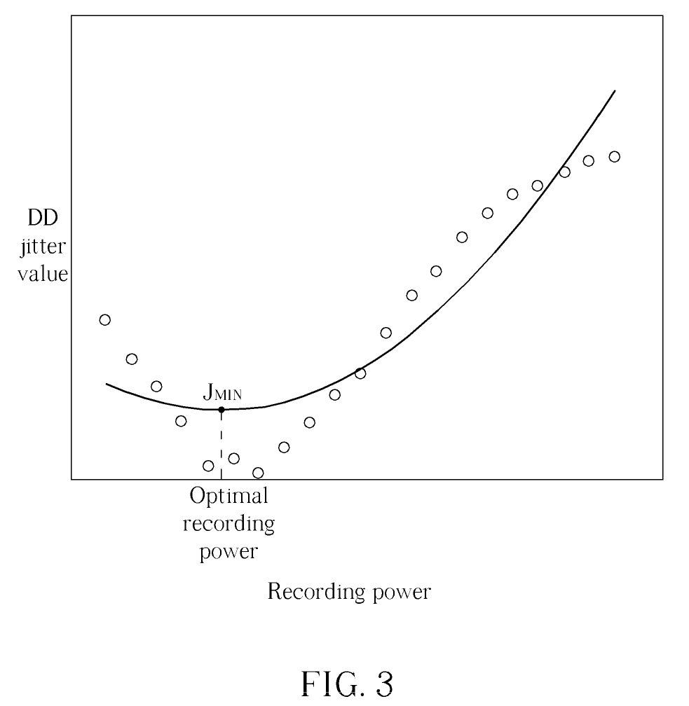

After the plurality of DD jitter values are determined, the calculation unit 140 generates a fitting-curve according to the DD jitter values, and an extreme value of the fitting-curve is set as a minimum jitter value. FIG. 3 is a diagram illustrating the fitting-curve of the DD jitter values. As shown in FIG. 3, the minimum jitter value occurs at point J_{MIN}, and a recording power corresponding to the point J_{MIN} serves as the optimal recording power.

It is noted that, in the OPC area, pits are formed with lengths from 2T to 9T, and the RF signals are generated correspondingly. Thus, the DD jitter values correspond to 2T-9T RF signals. However, because the 2T RF signal is unstable, the DD jitter values corresponding to the 2T RF signal are generally worse than the DD jitter values corresponding to 3T-9T RF signals. Therefore, the calculation unit 140 can also generate a fitting-curve of the DD jitter values, exclusive of jitter values of the 2T RF signal (i.e., the DD jitter values correspond to 3T-9T RF signals). An extreme value of this fitting-curve is set as a minimum jitter value, and a power corresponding to the minimum jitter value serves as the optimal recording power.

It is noted that, if the 2T RF signal is stable in the future, the 2T RF signal will be allowable to be taken for generating the fitting-curve.

In addition, the equalizer 120 is an optional device, and can be removed from the apparatus 100, thus the DD jitter meter 130 obtains a plurality of DD jitter values of the RF signals according to the RF signal and the clock signal CLK. The equalizer 120 behaves as a frequency shaper to filter out out-band noises, and boost in-band signals, thus the situation of jitter can be improved. However, when the quality of jitter is acceptable, the equalizer 120 can be removed.

Moreover, a so-called “walking-OPC” method is utilized to dynamically adjust the recording power of the laser during the writing process to ensure a greater quality consistency. However, in order to save the processing time and to calibrate the recording power on-the-fly according to the DD jitter values, several well-known parameters “beta target” and “beta slope” for OPC are utilized to calibrate the recording power on-the-fly.

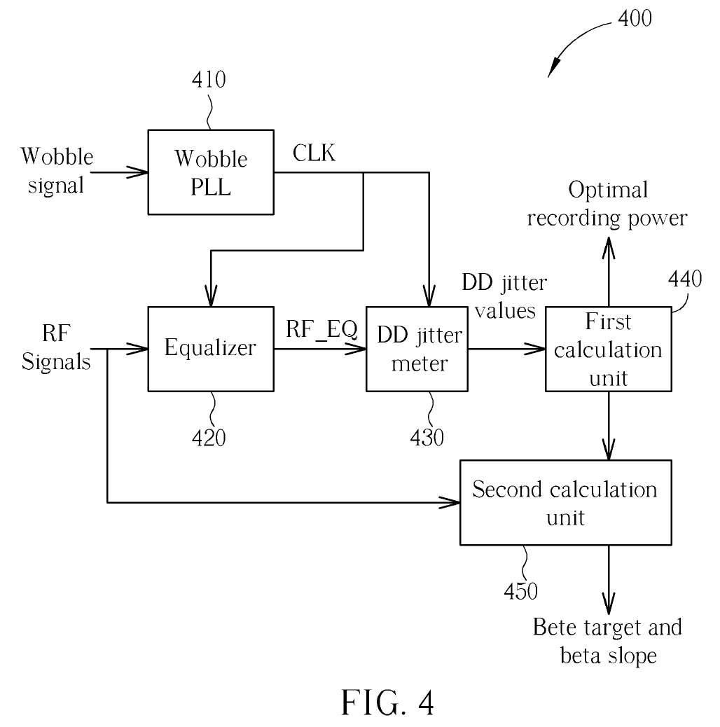

Please refer to FIG. 4. FIG. 4 is a diagram illustrating an apparatus 400 for calibrating an optical storage device according to a second embodiment of the present invention. As shown in FIG. 4, the apparatus 400 comprises a wobble PLL 410, an equalizer 420, a DD jitter meter 430, a first calculation unit 440, and a second calculation unit 450. The operations of the apparatus 400 are described as follows.

Functions of the wobble PLL 410, the equalizer 420, the DD jitter meter 430 and the first calculation unit 440 are respectively the same as the functions of the wobble PLL 110, the equalizer 120, the DD jitter meter 130 and the calculation unit 140 shown in FIG. 1. Therefore, further descriptions are omitted here. In this embodiment, an optimal recording power is determined according to a minimum jitter value generated from the first calculation unit 440. Then, the second calculation unit 450 determines a beta target value and a corresponding beta slope according to the optimal recording power.

It is noted that definitions of the “beta” is described by many references, such as the specifications of the optical storage devices, therefore, introduction is omitted here.

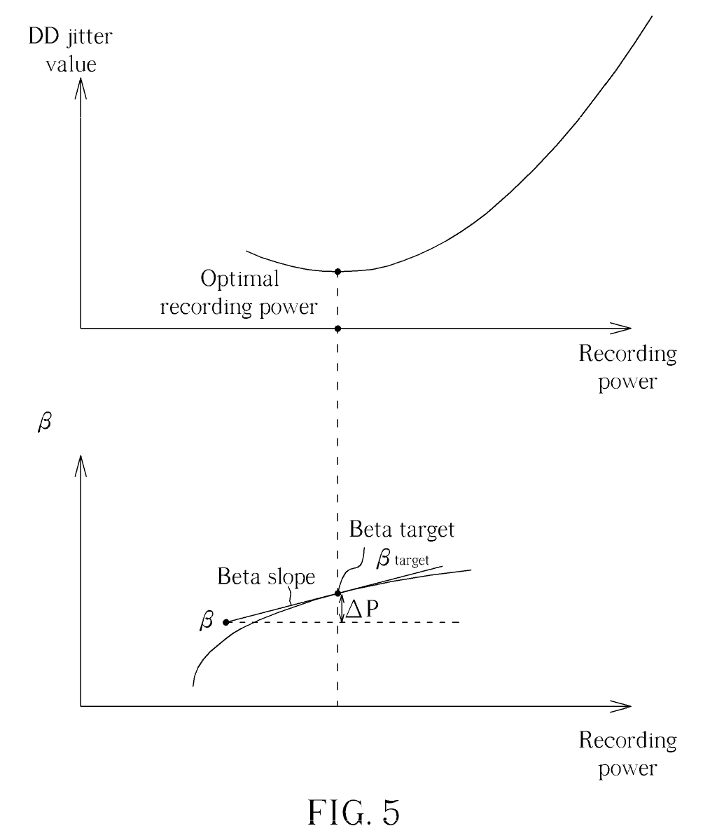

Please refer to FIG. 5. FIG. 5 is a diagram illustrating determination of the beta target β_{target} and the corresponding beta slope. As shown in FIG. 5, after the optimal recording power is determined from the first calculation unit 440, the second calculation unit 450 determines the beta target β_{target} according to the optimal recording power generated from the first calculation unit 440, and a slope of the curve at the beta target β_{target} serves as the beta slope. When the optical storage device writes data on the optical disc, the optimal recording power is adjusted by a value ΔP generated according to an on-line measured beta value β, where the ΔP is calculated as follows:

ΔP=(β−β_{target})/beta slope

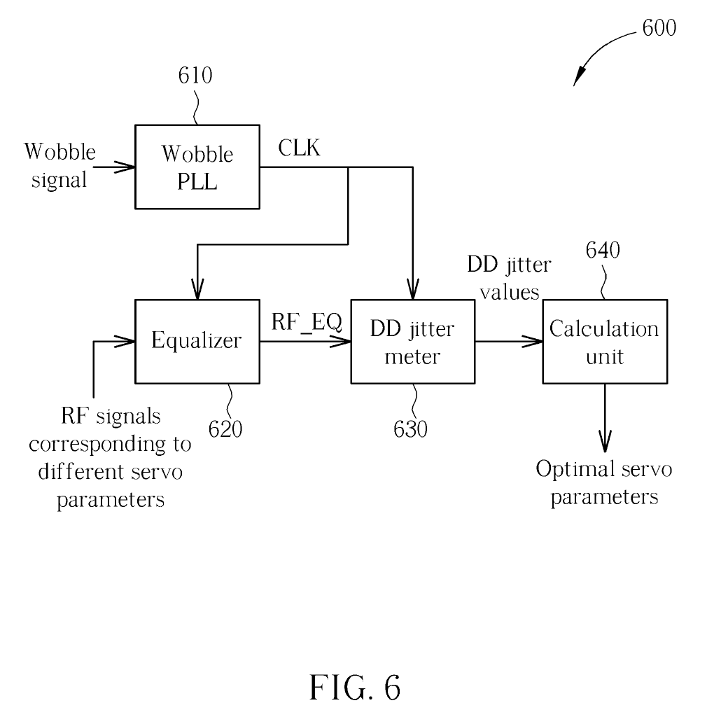

In addition, since quality of RF signals is also influenced by servo parameters (such as defocus, tracking error, tilt or spherical aberration), thus the implementations of the apparatus 100 can also be utilized to calibrate servo parameters, such as FIG. 6 shows.

Please refer to FIG. 6. FIG. 6 is a diagram illustrating an apparatus 600 for calibrating an optical storage device according to a third embodiment of the present invention. As shown in FIG. 6, the apparatus 600 comprises a wobble PLL 610, an equalizer 620, a DD jitter meter 630, and a calculation unit 640. In this embodiment, the jitter value represents the quality of RF signals with respect to specific servo parameter of different values. And the jitter values are obtained according to specific servo parameter set in sequence order, and those jitter values are used to find optimal servo parameter through the curve fitting.

Therefore, the user can use the apparatus 600 for calibration to obtain a specific optimal servo parameter. Also, the user can obtain a set of optimal servo parameters sequentially according to the servo parameters calibration by utilizing the apparatus 600. For example, the user can adjust the servo parameters, defocus, tracking error, tilt and spherical aberration sequentially, and the optimal servo parameters of the defocus, tracking error, tilt and spherical aberration are obtained respectively after the calibration.

Regarding the operations of the apparatus 600, the wobble signal is inputted into the wobble PLL 610 to generate a clock signal CLK, where a period of the clock signal CLK is 1T. The equalizer 620 receives the RF signals and generates an equalized RF signal RF_EQ according to the clock signal CLK. Then the DD jitter meter 630 obtains a plurality of DD jitter values of the RF signals according to the equalized RF signal RF_EQ and the clock signal CLK. Finally, the calculation unit 640 determines a minimum jitter value among the DD jitter values, and an optimal servo parameter combination (or a servo parameter) is determining according to the minimum jitter value.

It is noted that the apparatus 100 shown in FIG. 1 is similar to the apparatus 600 shown in FIG. 6 except for the corresponding information of the RF signals: in apparatus 100, the RF signals correspond to different recording powers, and in apparatus 600, the RF signals correspond to different servo parameters (or servo parameter combinations). Therefore, the apparatus 600 can perform optimal recording power calibration in the OPC area first in order to obtain an optimal recording power. Then, the pick-up head uses the optimal recording power to write data (in order to generate RF signal for later calibration used) onto a segment of the optical disc, where the segment is preferably in the OPC area. Then the apparatus 600 completes the calibration of servo parameters in the segment according to the written data.

Briefly summarized, according to the apparatuses and the methods for calibrating an optical storage device, a wobble PLL and a DD jitter meter are utilized to generate a plurality of DD jitter values, and an optimal recording power is determined according to the DD jitter values. Moreover, the optimal recording power is utilized to generate two parameters “beta target” and corresponding “beta slope”, these two parameters are for calibrating the recording power on-the-fly. In addition, an optical pick-up head utilizes the generated optimal recording power to write data onto a segment of the optical disc, and servo parameters are calibrated in the segment.

Those skilled in the art will readily observe that numerous modifications and alterations of the device and method may be made while retaining the teachings of the invention.

What is claimed is:

1. A method for calibrating an optical storage device, comprising:
providing a clock signal;
obtaining a plurality of data-to-data jitter values of a plurality of radio frequency (RF) signals according to the clock signal; and
determining a minimum jitter value among the data-to-data jitter values.

2. The method of claim 1, wherein the clock signal is generated according to a wobble signal.

3. The method of claim 1, wherein a period of the clock signal is 1T or 1T divided by a positive integer.

4. The method of claim 1, wherein the RF signals respectively correspond to different recording powers.

5. The method of claim 4, further comprising:
determining an optimal recording power according to the minimum jitter value for performing an optimal power calibration (OPC).

6. The method of claim 5, further comprising:
determining a beta target value and a corresponding beta slope according to the optimal recording power.

7. The method of claim 5, further comprising:
utilizing the optimal recording power to write data onto a segment of the optical disc; and
calibrating servo parameters in the segment.

8. The method of claim 1, wherein the RF signals respectively correspond to a plurality of parameter combinations, and each parameter combination comprises at least one servo parameter.

9. The method of claim 8, further comprising:
determining an optimal servo parameter according to the minimum jitter value for performing a servo parameter calibration.

10. The method of claim 1, wherein the step of determining the minimum jitter value comprises:
generating a fitting-curve according to the data-to-data jitter values; and
setting an extreme value of the fitting-curve as the minimum jitter value.

11. The method of claim 1, wherein the step of determining the minimum jitter value comprises:
generating a fitting-curve according to the data-to-data jitter values, exclusive of jitter values of a 2T RF signal; and
setting an extreme value of the fitting-curve as the minimum jitter value.

12. An apparatus for calibrating an optical storage device, comprising:
a clock generator arranged to provide a clock signal;
a jitter meter arranged to obtain a plurality of data-to-data jitter values of a plurality of radio frequency (RF) signals according to the clock signal; and
a first calculation unit arranged to determine a minimum jitter value among the plurality of data-to-data jitter values.

13. The apparatus of claim 12, wherein the clock generator is a wobble phase-locked loop circuit for generating the clock signal according to a wobble signal.

14. The apparatus of claim 12, wherein a period of the clock signal period is 1T or 1T divided by a positive integer.

15. The apparatus of claim 12, wherein the RF signals respectively correspond to different recording powers.

16. The apparatus of claim 15, wherein the first calculation unit further determines an optimal recording power according to the minimum jitter value for performing an optimal power calibration (OPC).

17. The apparatus of claim 16, further comprising:
a second calculation unit arranged to determine a beta target value and a corresponding beta slope according to the optimal recording power.

18. The apparatus of claim 12, wherein the RF signals respectively correspond to a plurality of parameter combinations, and each parameter combination comprises at least one servo parameter.

19. The apparatus of claim 18, wherein the first calculation unit further determines an optimal servo parameter according to the minimum jitter value for performing a servo parameter calibration.

20. The apparatus of claim 12, wherein the first calculation unit generates a fitting-curve according to the data-to-data jitter values and sets an extreme value of the fitting-curve as the minimum jitter value.

21. The apparatus of claim 12, wherein the first calculation unit generates a fitting-curve according to the data-to-data jitter values, exclusive of jitter values of a 2T RF signal; and sets an extreme value of the fitting-curve as the minimum jitter value.
